(19) United States
(12) Patent Application Publication
(10) Pub. No.: US 2010/0134216 A1
(43) Pub. Date: Jun. 3, 2010

(54) Resonator Tuning

(75) Inventor: Adham Naji, Bristol (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The University of Bristol, Bristol (GB)

(21) Appl. No.: 12/628,770

(22) Filed: Dec. 1, 2009

(30) Foreign Application Priority Data
Dec. 1, 2008 (GB) 0821925.5

(51) Int. Cl. H01P 7/08

(52) U.S. Cl. 333/235

(57) ABSTRACT

A resonator comprises an annular conductor, in the form of a primary annular conductor component and at least one secondary annular conductor component located inwardly of the primary annular conductor component, with the annular conductor components spaced apart from each other. The resonator further comprises controllable switches, for selectively connecting the one or more secondary annular conductor component to the primary annular conductor component, in order to adjust the resonant properties of the resonator.

This invention relates to the tuning of resonator systems, and in particular to resonator systems whose centre frequency can be adjusted.

Resonators are widely used in situations where electromagnetic signals or fields are being generated or detected. A body made of a conductive material with a dielectric substrate will resonate at a particular frequency, with that resonant frequency corresponding to a particular wavelength that is related to the dimensions of the body and the material properties of the body. Where the body is effectively one-dimensional, this relationship is relatively straightforward. However, where the body is two- or three-dimensional, or where there is coupling between two or more such bodies, the relationship becomes more complex.

In one well-known form of resonator, a generally square, thin (that is, effectively two-dimensional) layer, or patch, of conductive material is provided. An effectively two-dimensional body of this type has two resonant modes, relating to oscillations along the width and the length of the patch respectively. In each case, the resonant frequency of the mode corresponds to a wavelength which is approximately double the respective dimension of the patch.

It is known from U.S. Pat. No. 6,501,427 that a patch antenna can be formed from a segmented patch, in the shape of a square, where additional patch segments around the outside of the square can be connected to the primary patch segment by MEMS switches to form a larger square, and therefore adjust the resonant frequency of the antenna.

However, this has the disadvantage that adjusting the size and shape of the patch in this way affects the optimal positions of the feeds or the feeding probes, and so the coupling between the feeds and the patch is adversely affected as the size of the patch is adjusted.

According to a first aspect of the present invention, there is provided a resonator, having an aperture therein, wherein the size of the aperture is adjustable in order to adjust resonant properties of the resonator.

In embodiments of the invention, the resonator comprises an annular conductor having a primary annular conductor component and at least one secondary annular conductor component located inwardly of the primary annular conductor component, with the annular conductor components spaced apart from each other, and further comprising controllable switches, for selectively connecting the one or more secondary annular conductor component to the primary annular conductor component.

According to a second aspect of the present invention, there is provided a method of tuning a resonator, having an aperture therein, the method comprising adjusting a size of the resonator such that the resonator has desired resonant properties.

In embodiments of the invention, in which the resonator comprises an annular conductor having a primary annular conductor component and at least one secondary annular conductor component located inwardly of the primary annular conductor component, with the annular conductor components spaced apart from each other, the method comprises selectively opening and closing controllable switches, for selectively connecting the one or more secondary annular conductor component to the primary annular conductor component in order to adjust the effective size of the aperture.

This has the advantage that the resonator can be tuned, without adversely affecting the coupling between feed lines, that terminate adjacent an outer edge of the resonator, and the resonator itself.

For a better understanding of the present invention, and to show how it may be put into effect, reference will now be made, by way of example, to the accompanying drawings, in which:

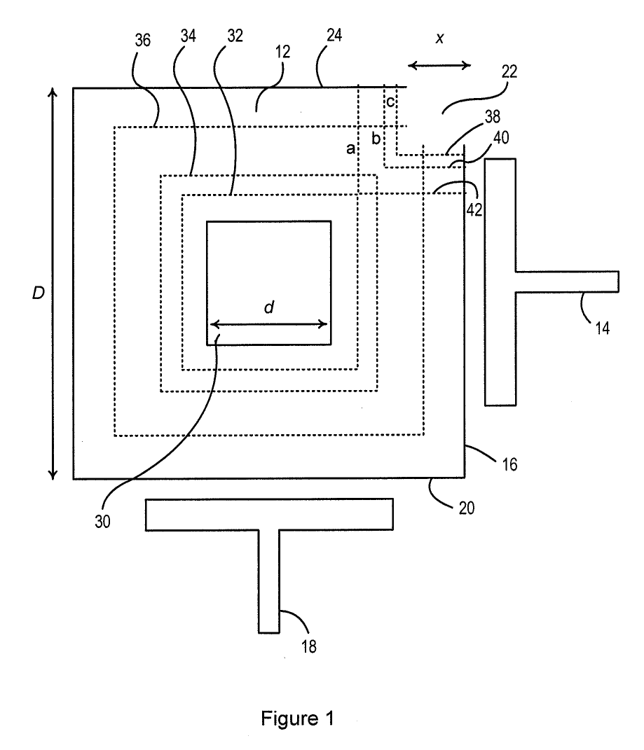

FIG. 1 is a schematic diagram, illustrating a principle of operation of a resonator system in accordance with the present invention.

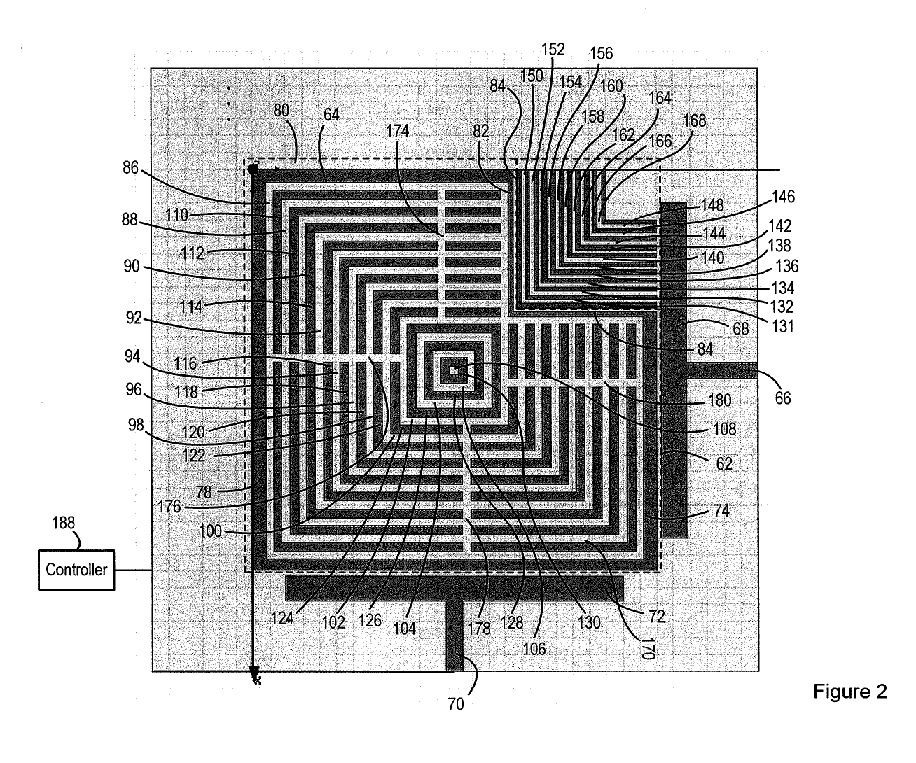

FIG. 2 shows a first resonator in accordance with the present invention, in a first use condition.

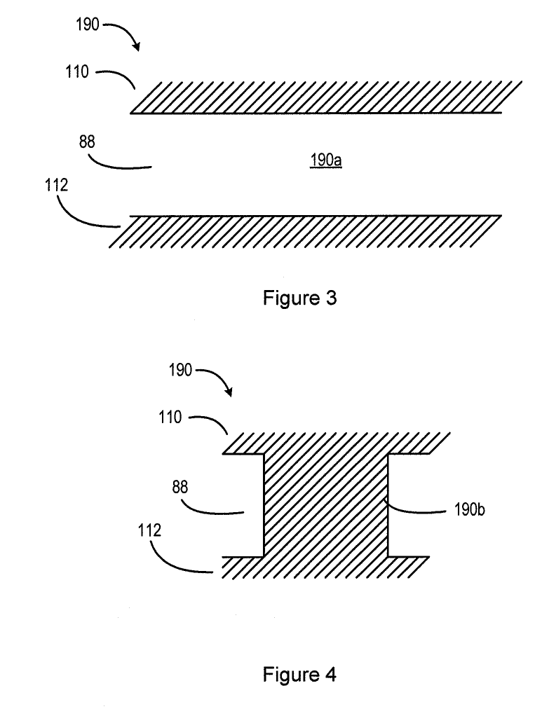

FIGS. 3 and 4 show in more detail a switch on the resonator of FIG. 2.

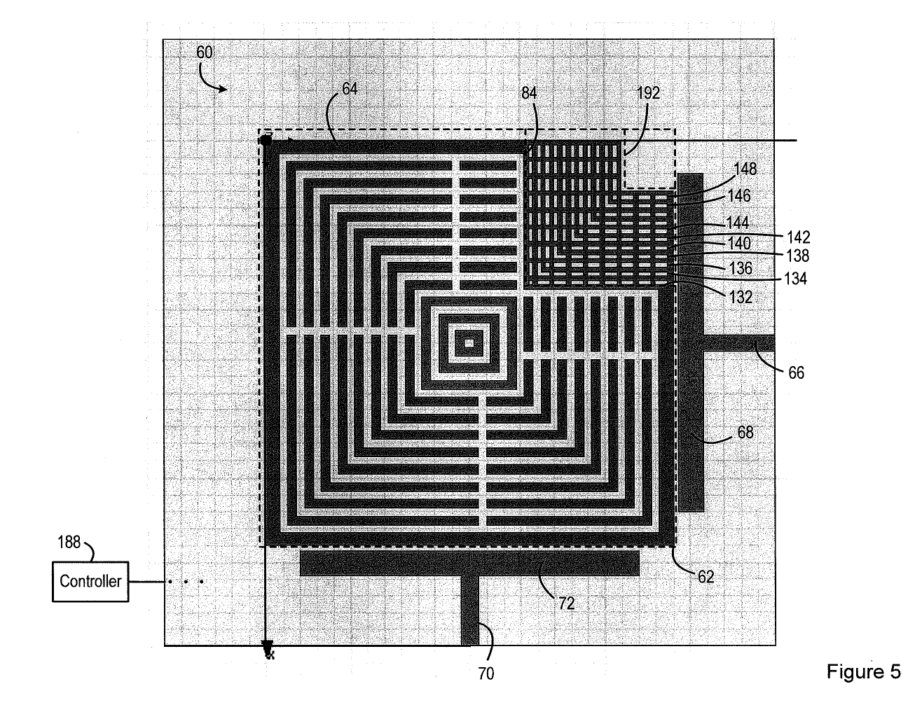

FIG. 5 shows the resonator of FIG. 2, in a second use condition.

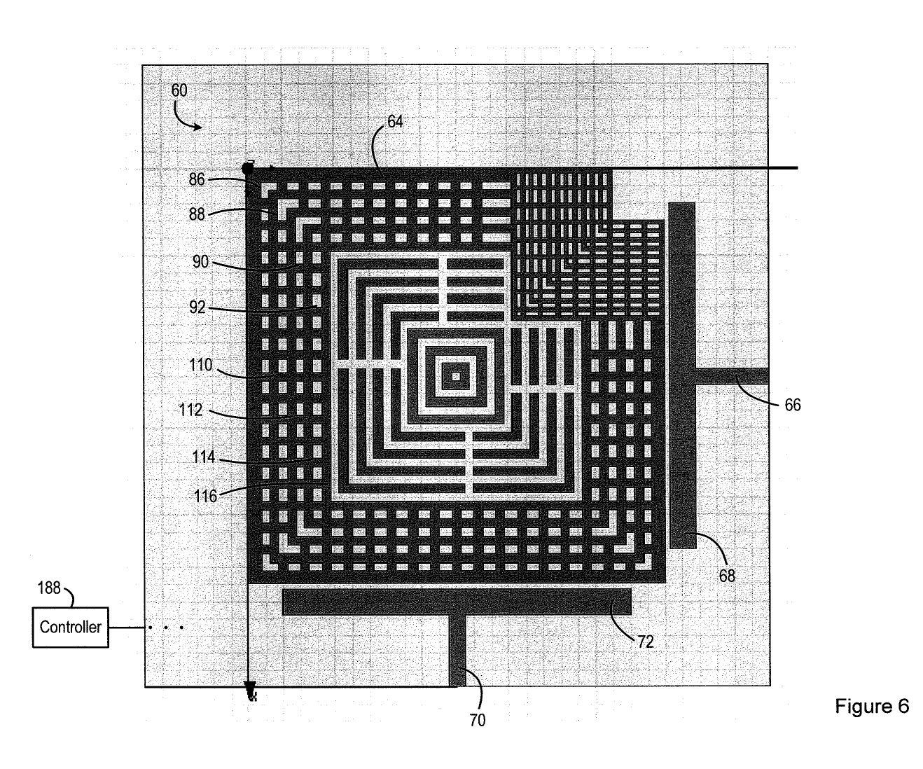

FIG. 6 shows the resonator of FIG. 2, in a third use condition.

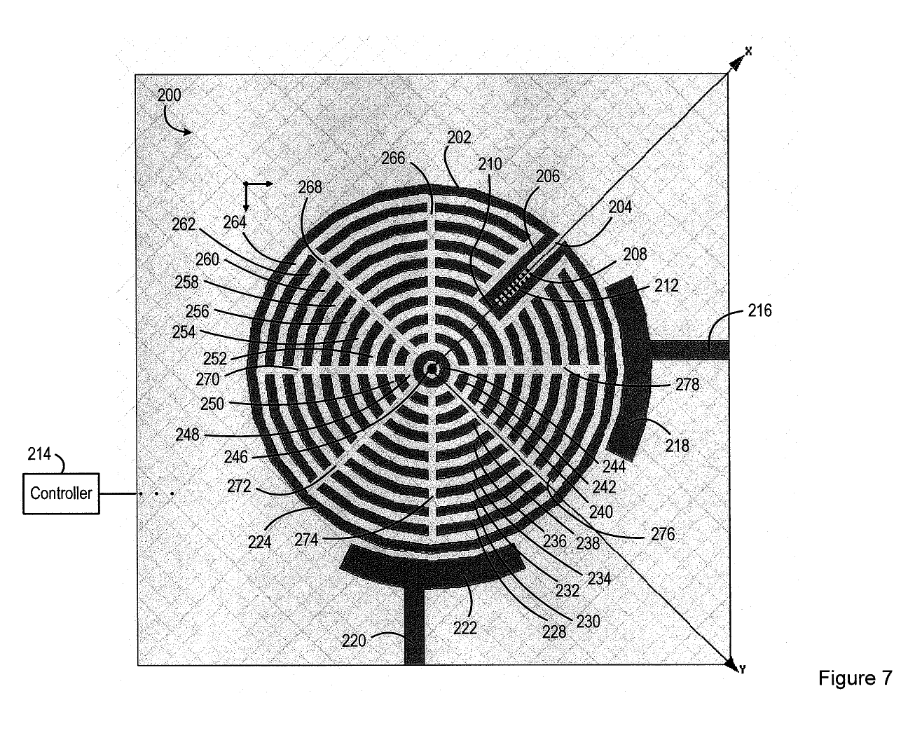

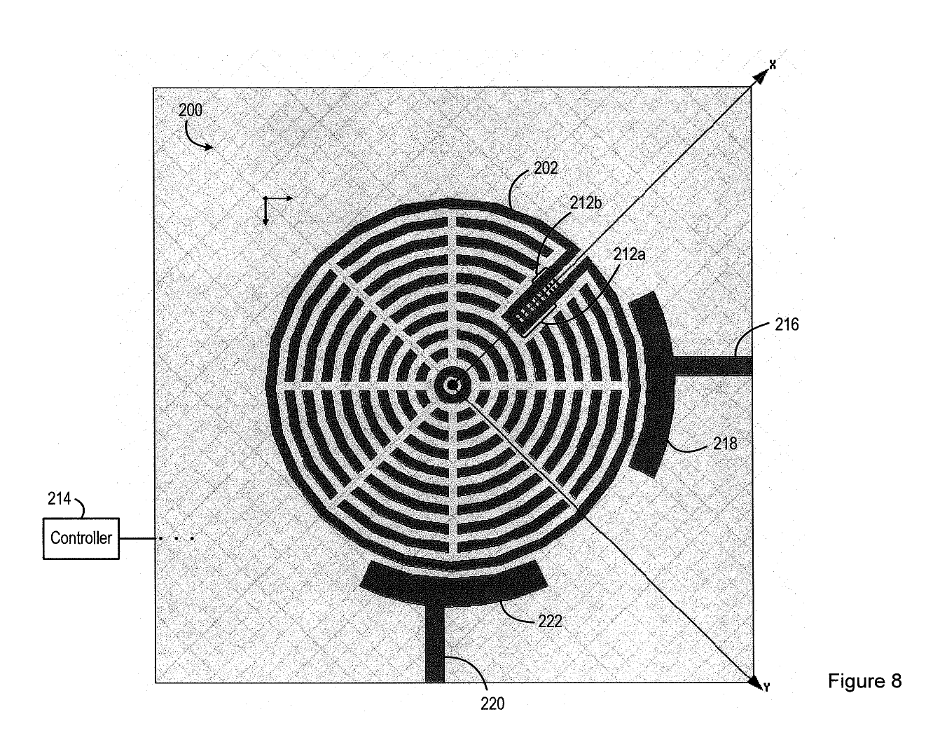

FIG. 7 shows a second resonator in accordance with the present invention, in a first use condition.

FIG. 8 shows the resonator of FIG. 7, in a second use condition.

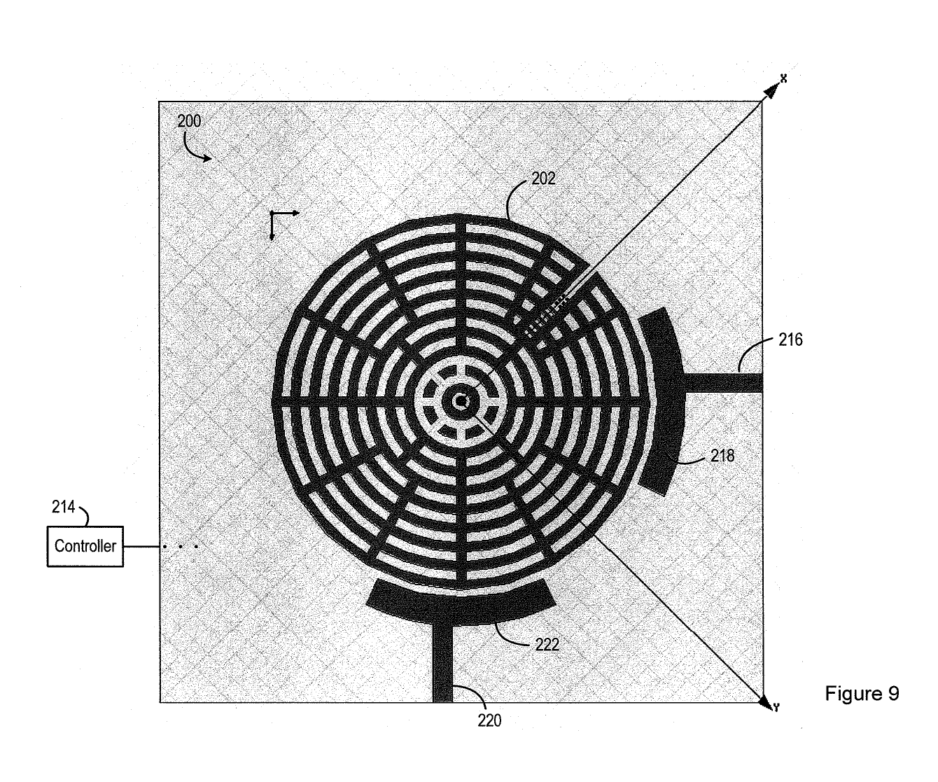

FIG. 9 shows the resonator of FIG. 7, in a third use condition.

FIG. 1 shows a resonator system with a single symmetric resonator 10. The resonator 10 is formed from a patch of a conductive material 12, such as a metal, sandwiched between two ground planes (not shown in FIG. 1). In other embodiments of the invention, there may be only one ground plane. The patch 12 is generally square, of side length D and planar (extending in the horizontal and vertical directions in the orientation shown in FIG. 1). The patch 12 is mounted on a substrate (not shown in FIG. 1), formed of a dielectric material. The patch has two resonant modes, with a first mode extending in the horizontal direction and a second mode extending in the vertical direction. The dimensions of the patch and the dielectric material properties of the substrate determine the frequencies of these resonant modes. More specifically, the side length D of the patch in each of these directions determines the wavelength λ of the respective resonant mode, by the relationship D≈λ/2.

By suitable choice of dimensions, resonators in accordance with the present invention, such as the resonator 10, can be used at any desired frequency, but a typical application is in radio frequency, microwave and millimetre communications, where the required frequency of operation means that the dimensions of the patch 12 in the horizontal and vertical directions will be of the order of the wavelength, usually a few millimetres or a few centimetres. The patch 12 is generally thin, in the sense that the thickness of the patch, perpendicular to the plane of FIG. 1, will be considerably smaller than the dimensions in the horizontal and vertical x- and y-directions. It will be appreciated that the same technique can be used, with suitable modification, in the case of a three-dimensional resonator.

A first feed line 14 is connected to supply energy to and/or from the patch 12 at a point which, in this illustrated embodiment, is half way along a first side 16 of the patch, while a second feed line 18 is connected to supply energy to and/or from the patch 12 at a point which, in this illustrated embodiment, is half way along a second side 20 of the patch, the second side 20 being adjacent to the first side 16. Thus, the first feed line 14 is connected to the first resonant mode of the patch, and the second feed line 18 is connected to the second resonant mode of the patch.

In this case, the shape of the patch 12 is modified, in order to achieve a degree of coupling between the first and second resonant modes. Specifically, a notch 22 is formed in the patch 12, at the corner between the first side 16 and a third side 24 of the patch 12, where the third side 24 is opposite the second side 20. The notch 22 extends from the corner of the square by a distance x along the sides 16, 24 of the patch 12. In other embodiments, the notch could be of any shape, and could be at any corner of the patch, or could be formed elsewhere in the patch, with the same principle applying.

The size of the notch 22 has an effect on the resonant properties of the patch 12, because the degree of coupling between the resonant modes affects the overall frequency response of the patch resonator. If there is no notch 22, the first and second resonant modes are effectively uncoupled from each other, and the degree of coupling between them increases as the size of the notch 22 increases. If the degree of coupling is at a critical level, the frequency response includes a resonance at a particular frequency. If the degree of coupling is below this critical level, the resonator becomes less efficient. As the degree of coupling increases above the critical level, the resonant peak splits into two separate peaks, spread over a wider range of frequencies. Provided that these two peaks are not too widely spread, the resonator has a larger operating bandwidth.

The resonant frequency of the resonator 10 can also be adjusted. As shown in FIG. 1, a generally square aperture 30, of side length d, is formed in the centre of the patch 12.

It has now been found that the resonant frequency of the resonator depends on the size of the aperture 30. If the periphery of the aperture 30 is extended outwards as shown by the square 32, or further outwards as shown by the square 34, or still further outwards as shown by the square 36, the wavelength of resonance also increases, and hence the frequency shifts to a lower value, thus achieving frequency tuning.

In addition, as mentioned above, while the resonator 10 can be thought of as having two oscillating modes propagating parallel to the feeds, the presence of the notch 22 causes coupling of these otherwise orthogonal degenerate modes by flipping them by 90° from one feed to another. The degree of coupling between the resonant modes is determined by the size of the notch and, for example, if the dimension x is extended so that the notch 22 stretches outwards to the line 38, or further outwards to the line 40, or still further outwards to the line 42, the coupling increases with the size of the notch, and the bandwidth, encompassing the two resonant peaks, widens.

In fact, if the size of the aperture 30 is fixed while the size of the notch 22 is adjusted, there will be an effect on the coupling between the resonant modes as well as on the resonant frequency. Similarly, if the size of the notch 22 is fixed while the size of the aperture 30 is adjusted, there will be an effect on the resonant frequency as well as on the coupling between the resonant modes. Therefore, in order to achieve apparently independent tuning of one of the coupling and the resonant frequency, it is particularly advantageous to be able to control both of the size of the aperture and the size of the notch.

FIG. 2 shows in more detail a structure in accordance with an embodiment of the present invention.

Specifically, FIG. 2 shows a resonator 60 formed of a conductive material, such as a metal, sandwiched between two ground planes (not shown in FIG. 2). Again, in other embodiments of the invention, there may be only one ground plane. The conductive material is planar (extending in the horizontal and vertical directions in the orientation shown in FIG. 2). The conductive material is mounted on a substrate (not shown in FIG. 1), formed of a dielectric material.

As will be recognised, the resonator 60 thus has a first resonant mode in the horizontal direction in FIG. 2 and a second resonant mode in the vertical direction in FIG. 2. These degenerate modes are therefore orthogonal.

In the configuration shown in FIG. 2, the resonator 60 lies wholly within a square 62, such that the resonator is effectively symmetrical, and takes the form of a generally square shaped annular track 64 of conductive material.

A first feed line has a component 66 extending in the horizontal direction, connected to a component 68 that extends in the vertical direction, along the outside of a major central portion of a first side of the square 62, and is therefore connected to supply energy to and/or from the resonator 60. More specifically, the first feed line 66, 68 is connected to supply energy to and/or from the first resonant mode of the resonator 60. A second feed line has a component 70 extending in the vertical direction, connected to a component 72 that extends in the horizontal direction, along the outside of a major central portion of a second side of the square 62, perpendicular to the first side of the square 62. The second feed line 70, 72 is therefore connected to supply energy to and/or from the resonator 60. More specifically, the second feed line 70, 72 is connected to supply energy to and/or from the second resonant mode of the resonator 60.

The track 64 of conductive material has a first component 74 extending along the inside of the first side of the square 62. In this embodiment, the first component 74 of the track 64 extends along about 55%-80%, for example about 65% of the length of the first side of the square 62, from a point somewhat above the centre of the first side to the point where the first side meets the second side.

A second component 76 of the track 64 extends along the second side of the square 62, a third component 78 extends along a third side of the square 62 parallel to the first side, and a fourth component 80 extends along a fourth side of the square 62 parallel to the second side. In this embodiment, the fourth component 80 of the track 64 extends along about 55%-80%, for example about 65% of the length of the fourth side of the square 62, from the point where the fourth side meets the third side to a point somewhat to the right of the centre of the fourth side. The length of the forth component 80 is equal to the length of the first component 74.

The track 64 then has a fifth component 82, extending from the right hand end of the fourth component 80 perpendicular thereto. The fifth component 82 is connected to a sixth component 84, which is perpendicular thereto, and which is also connected to the upper end of the first component 74.

Thus, the track 64 extends around the perimeter of a shape which is effectively formed by taking the square 62, and removing a smaller square 84 from its upper right hand corner. The square from which material has been removed forms a notch, which introduces coupling between the orthogonal modes of the resonator. The notch could be of other shapes, such as rectangular, instead of square.

Although FIG. 2 shows a resonator that is square, albeit with a notch removed from the square, the invention is equally applicable to resonators having other shapes, and in particular other polygonal shapes, especially other symmetric polygonal shapes.

Located within the track 64, there are a series of concentric square tracks 86, 88, 90, 92, 94, 96, 98, 100, 102, 104, 106, 108 of non-conductive material, alternating with concentric square tracks 110, 112, 114, 116, 118, 120, 122, 124, 126, 128, 130 of conductive material.

As can be seen from FIG. 2, the outer tracks extend within the square 62, but terminate where they meet the edge of the smaller square 84, while the inner tracks 102, 104, 106, 108 and 126, 128, 130 are of square shape.

In addition, located within the smaller square 84, there are a series of tracks 131, 132, 134, 136, 138, 140, 142, 144, 146, 148 of non-conductive material, alternating with tracks 150, 152, 154, 156, 158, 160, 162, 164, 166, 168, 170 of conductive material.

Each of these tracks has components extending parallel to the fifth and sixth sides respectively of the track 64. These tracks are therefore in the shape of concentric quarter square, centred on the upper right hand corners of the square 62 and of the smaller square 84, as these points coincide.

There are also tracks of non-conductive material 174, 176, 178, 180 extending outwardly from the centre of the square 62, starting from the concentric track 102, and these tracks 174, 176, 178, 180 interrupt the concentric tracks 110, 112, 114, 116, 118, 120, 122, 124 conductive material, ensuring that none of these tracks extends around more than one quarter of the square 62. There may be a different number of these outwardly extending tracks of non-conductive material, so that the length of the tracks of conductive material is limited to some other fraction of the square. This has the advantage that, when energy is supplied to the resonator 60, the concentric tracks of conductive material are not excited with fringing energy resonance(s) at a nearby frequency.

As shown in FIG. 2, the track 64 is therefore the only effective part of the resonator 60. That is, the resonator 60 extends around the periphery of the shape defined by the square 62 with the smaller square 84 removed, and has a width equal to the width of the track 64. The area inside the track 64 forms an aperture, which is itself effectively symmetrical. It will be noted that the aperture is the same shape as the resonator itself. However, the invention is equally applicable to embodiments in which the aperture is of a different shape to the resonator. For example, a circular aperture can be formed within a square resonator.

Each of the concentric tracks 86, 88, 90, 92, 94, 96, 98, 100, 102, 104, 106, 108 of non-conductive material within the track 64, and each of the tracks 132, 134, 136, 138, 140, 142, 144, 146, 148 of non-conductive material within the smaller square 84, contains multiple switches, which can be used to bridge the non-conductive material.

Specifically, the switches bridging the tracks of non-conductive material may be MEMS switches, and may be of a type suitable for use at radio or microwave frequencies, where the resonator 60 is intended for use at such frequencies. Each of the switches is controlled by a controller 188, although for clarity FIG. 2 does not show the connections from the controller 188 to the switches. The controller can have separate connections to each of the switches, allowing each of the switches to be controlled individually, or it can have connections which allow all of the switches bridging one non-conductive track to be opened and closed together.

The switches must be placed sufficiently close to each other that, when two adjacent switches are closed, such that two areas of conductive material are electrically connected together, the whole area comprising the two areas of conductive material and the area between them from which the conductive material has been removed can nevertheless effectively act as a single conductive body.

For example, there may be sixteen switches equally spaced along each of the four sides of the outer non-conductive track 86, reducing to two switches equally spaced along each of the four sides of the inner non-conductive track 106. Similarly, there may for example be eight switches along each of the two limbs of the longest track 150 of non-conductive material in the smaller square 84, reducing to three switches along each of the two limbs of the shortest track 168.

FIG. 3 shows a representative one of the switches 190 in an open position. Specifically, FIG. 3 shows a switch 190 that is located in the track 88 of non-conductive material, between the tracks 110, 112 of conductive material.

In the configuration shown in FIG. 3, the switch 190 is controlled such that there remains a gap 190a, and so there is no conductive path between the conductive tracks 110, 112.

FIG. 4 shows the switch 190 in a closed position. In the configuration shown in FIG. 4, the switch 190 is controlled so that there is a continuous conductive path 190b between the conductive tracks 110, 112.

When the switches bridging a non-conductive region are closed, the effect is that the tracks of conductive material on either side of that non-conductive region form a single conductive region, and the resonant properties of the resonator change accordingly.

Thus, FIG. 5 shows the device 60 of FIG. 2, in a situation in which all of the switches bridging all of the tracks of non-conductive material 132, 134, 136, 138, 140, 142, 144, 146, 148 are closed. The result is that all of the conductive tracks in the smaller square 84 are electrically connected to the track 64.

As shown in FIG. 5, therefore, the resonator 60 effectively extends around the periphery of the shape defined by the square 62 with the small square 192 removed, and has a width equal to the width of the track 64, except within the square 84, where it has an increased width.

The result is that the degree of coupling between the resonant modes of the system is different from when these switches are open. Specifically, the coupling is reduced, because the effective size of the notch formed in the upper right hand corner of the square 62 is reduced.

FIG. 6 shows the device 60 of FIG. 2 in a further use condition. Specifically, FIG. 6 shows the device 60 in a situation in which all of the switches bridging the tracks 86, 88, 90, 92 of non-conductive material are closed, while the switches bridging the other tracks of non-conductive material are open. The result is that the tracks 110, 112, 114, 116 of conductive material are all connected to the primary track 64.

As shown in FIG. 6, therefore, the resonator 60 effectively extends around the periphery of the shape defined by the square 62 with the small square 192 removed, and has a width equal to the width of the track 64 plus the widths of the tracks 86, 88, 90, 92 of non-conductive material and the tracks 110, 112, 114, 116 of conductive material. Again, the resonator has an increased width within the square 84.

Effectively, therefore, closing the switches bridging the tracks of non-conductive material has increased the solid area of the conductive material, and has reduced the size of the aperture within the solid material. This means that the resonant frequency of the resonator is increased, because the wavelength has been reduced.

Moreover, this has been achieved without significantly affecting the connections between the feed lines 66, 68 and 70, 72 and the conductive material.

Thus, by determining which of the switches should be opened and closed, the effective size of the aperture in the conductive material can be varied, and also the coupling between the resonant modes of the resonator can independently be varied, with the result that the resonant properties of the resonator can be controlled.

The invention is equally applicable to patch resonators of other shapes.

As an example, FIGS. 7, 8 and 9 show one such alternative embodiment of the invention, where the resonator system includes an annular circular resonator.

In this embodiment of the invention, the resonator 200 includes a ring 202 of conductive material. The ring 202 extends through almost the full 360° of a circle, but there is a notch 204 at one point. The conductive material then has straight arms 206, 208 extending inwardly from the circumference of the circle at this notch. At their inward ends, the arms 206, 208 are joined by a connecting piece 210. In addition, switches 212 bridge the notch 204 at different points along its length. The switches 212 are controlled by a controller 214.

As before, the conductive material may be a metal, and is sandwiched between two ground planes (not shown in FIG. 7), but again, in other embodiments of the invention, there may be only one ground plane. The conductive material is planar (extending in the horizontal and vertical directions in the orientation shown in FIG. 7), and is mounted on a substrate (not shown in FIG. 7), formed of a dielectric material.

As will be recognised, the resonator 200 is therefore effectively symmetrical, and thus has a first resonant mode in the horizontal direction in FIG. 7 and a second resonant mode in the vertical direction in FIG. 7, with the orthogonal first and second modes being degenerate.

A first feed line has a component 216 extending in the horizontal direction, connected to a component 218 that extends in both directions, around the outside of the ring 202, from the point where it joins the component 216, and is therefore connected to supply energy to and/or from the resonator 200. More specifically, the first feed line 216, 218 is connected to supply energy to and/or from the first resonant mode of the resonator 200. A second feed line has a component 220 extending in the vertical direction, connected to a component 222 that extends in both directions, around the outside of the ring 202, from the point where it joins the component 220. The second feed line 220, 222 is therefore connected to supply energy to and/or from the resonator 200. More specifically, the second feed line 220, 222 is connected to supply energy to and/or from the second resonant mode of the resonator 200.

The position of the notch 204 is such that it is inclined at an angle of 45° to the feeds, so that it introduces coupling between the resonant modes. The position could instead be such that this angle is, say, 40° or 30°, but this would affect the amount of coupling.

The primary component of the ring 202 of conductive material is an outer track 224. Located within the track 224, there are a series of concentric circular tracks 228, 230, 232, 234, 236, 238, 240, 242, 244 of conductive material, alternating with concentric circular tracks 246, 248, 250, 252, 254, 256, 258, 260, 262, 264 of non-conductive material.

As can be seen from FIG. 7, the outer conductive tracks 228, 230, 232, 234, 236 terminate where they meet the notch 204, while the inner conductive tracks 238, 240, 242, 244 extend around a whole circle.

There are also tracks of non-conductive material 266, 268, 270, 272, 274, 276, 278 extending outwardly from the centre of the ring 202, and these tracks interrupt the concentric tracks of conductive material, ensuring that none of these tracks extends around more than one eighth of a circle. There may be a different number of these radially extending tracks of non-conductive material, so that the length of the tracks of conductive material is limited to some other fraction of the circle. This has the advantage that, when energy is supplied to the resonator 200, the concentric tracks of conductive material have little undesired effect on the resonance(s).

As shown in FIG. 7, the outer track 224 is therefore the only effective part of the resonator 200. That is, the resonator 260 extends around the circle, with the exception of a notch 204 that extends the full length of the arms 206, 208, and has a width equal to the width of the track 224.

The result is that the annular conductor forming the resonator has its minimum thickness or, put another way, the central aperture has its maximum size. This means that the resonator has its minimum resonant frequency. Also, the notch has its maximum possible length, meaning that the coupling between the resonant modes of the resonator is at its maximum, and hence that the resonator has its maximum possible bandwidth.

Again, it should be noted that, while FIG. 7 shows a circular resonator with a circular aperture, the aperture may be of a different shape to the resonator. For example, a circular resonator may contain a square aperture.

Each of the concentric tracks 246, 248, 250, 252, 254, 256, 258, 260, 262, 264 of non-conductive material, and each of the radial tracks 266, 268, 270, 272, 274, 276, 278 of non-conductive material, contains multiple switches, which can be used to bridge the non-conductive material. In addition, as mentioned above, multiple switches 212 bridge the notch 204.

Specifically, these switches may be MEMS switches, and may be of a type suitable for use at radio or microwave frequencies, where the resonator 200 is intended for use at such frequencies. Each of the switches is controlled by a controller 214, although for clarity FIG. 7 does not show the connections from the controller 214 to the switches. The controller can have separate connections to each of the switches, allowing each of the switches to be controlled individually, or it can have connections which allow all of the switches bridging one non-conductive track to be opened and closed together.

The switches must be placed sufficiently close to each other that, when two adjacent switches are closed, such that two areas of conductive material are electrically connected together, the whole area comprising the two areas of conductive material and the area between them from which the conductive material has been removed can nevertheless effectively act as a single conductive body.

For example, there may be twelve switches equally spaced around each of the outer non-conductive track 86, reducing to eight switches equally spaced around each of the inner non-conductive tracks. For example, there may be eight switches 212 bridging the notch 204.

The switches may be as shown in FIGS. 3 and 4.

When the switches bridging a non-conductive region are closed, the effect is that the tracks of conductive material on either side of that non-conductive region form a single conductive region, and the resonant properties of the resonator change accordingly.

Thus, FIG. 8 shows the device 200 of FIG. 7, in a situation in which a first group 212a of the switches bridging the notch 204 are closed, while a second group 212b of the switches bridging the notch 204 remain open.

The result is that the degree of coupling between the resonant modes of the system is different from when these switches 212 are all open. Specifically, the coupling is reduced, because the effective size of the notch 204 is reduced.

FIG. 9 shows the device 200 of FIG. 7 in a further use condition. Specifically, FIG. 9 shows the device 200 in a situation in which all of the switches bridging the outer tracks 250, 252, 254, 256, 258, 260, 262, 264 of non-conductive material are closed. In addition, the switches bridging the radial tracks 266, 268, 270, 272, 274, 276, 278 are closed within these circular tracks. The switches bridging the inner tracks 246, 248 of non-conductive material are open. The result is that the tracks 226, 228, 230, 232, 234, 236, 238, 240 of conductive material are all connected to the primary track 224.

As shown in FIG. 9, therefore, the resonator 200 effectively now has a width equal to the width of the track 224 plus the widths of the tracks 226, 228, 230, 232, 234, 236, 238, 240 of conductive material and the tracks 250, 252, 254, 256, 258, 260, 262, 264 of non-conductive.

Effectively, therefore, closing the switches bridging the tracks of non-conductive material has increased the solid area of the conductive material, and has reduced the size of the aperture within the solid material. This means that the resonant frequency of the resonator is increased, because the wavelength has been reduced.

Moreover, this has been achieved without significantly affecting the connections between the feed lines 216, 218 and 220, 222 and the conductive material.

Thus, by determining which of the switches should be opened and closed, the effective size of the aperture in the conductive material can be varied, and also the coupling between the resonant modes of the resonator can independently be varied, with the result that the resonant properties of the resonator can be controlled.

Although the invention is described herein with reference to resonator systems that include two-dimensional patch resonators, it will be appreciated that the invention is equally applicable to three-dimensional resonators.

Resonator systems as described herein can be useful in tunable radio frequency or microwave antennas, matching networks, phase shifters, duplexers, and other radio frequency or microwave circuitry, where frequency tuning and/or coupling tuning is required.

1. A resonator, having an aperture therein, wherein the size of the aperture is adjustable in order to adjust resonant properties of the resonator.

2. A resonator as claimed in claim 1, wherein the resonator has a symmetric shape.

3. A resonator as claimed in claim 1, wherein the aperture has a symmetric shape.

4. A resonator as claimed in claim 1, wherein the resonator comprises an annular conductor having a primary annular conductor component and at least one secondary annular conductor component located inwardly of the primary annular conductor component, with the annular conductor components spaced apart from each other, and further comprising controllable switches, for selectively connecting the one or more secondary annular conductor component to the primary annular conductor component.

5. A resonator as claimed in claim 4, comprising a plurality of secondary annular conductor components spaced apart from each other, wherein the controllable switches selectively connect the secondary annular conductor components to each other and to the primary conductor component.

6. A resonator as claimed in claim 1, wherein the resonator is circular.

7. A resonator as claimed in claim 1, wherein the resonator is polygonal.

8. A resonator as claimed in claim 7, wherein the resonator is square.

9. A resonator as claimed in claim 1, wherein the size of a notch in the resonator is adjustable in order to adjust resonant properties of the resonator.

10. A resonator as claimed in claim 1, further comprising feed lines for transferring energy to and/or from the resonator, wherein the feed lines terminate adjacent an outer edge of the resonator.

11. A method of tuning a resonator, having an aperture therein, the method comprising adjusting a size of the resonator such that the resonator has desired resonant properties.

12. A method as claimed in claim 11, wherein the resonator comprises an annular conductor having a primary annular conductor component and at least one secondary annular conductor component located inwardly of the primary annular conductor component, with the annular conductor components spaced apart from each other, the method comprising selectively opening and closing controllable switches, for selectively connecting the one or more secondary annular conductor component to the primary annular conductor component in order to adjust the effective size of the aperture.
